(19) United States
(12) Patent Application Publication
(10) Pub. No.: US 2026/0299816 A1
(43) Pub. Date: Oct. 1, 2026

(54) MULTI-STREAM FOLDING SCHEME IN A MEMORY SUB-SYSTEM

(71) Applicant: Micron Technology, Inc., Boise, ID (US)

(72) Inventors: Donghua Zhou, Suzhou City (CN); Meng Wei, Shanghai (CN)

(21) Appl. No.: 19/089,368

(22) Filed: Mar. 25, 2025

(51) Int. Cl. G06F 3/06

(52) U.S. Cl. CPC G06F 3/0655; G06F 3/0604; G06F 3/0679

(57) ABSTRACT

A system includes a memory device; and a processing device, operatively coupled with the memory device, to perform operations including receiving a host write request to write host data to the memory device; receiving a plurality of folding requests to perform a plurality of folding operations in the memory device, wherein each folding request of the plurality of folding requests corresponds to a respective folding operation of the plurality of folding operations; identifying, for each folding request of the plurality of folding requests, a type of folding request of a plurality of types of folding requests; determining a plurality of credit values, wherein each credit value of the plurality of credit values corresponds to a respective folding request of the plurality of folding requests, and wherein each credit value of the plurality of credit values is determined according to a respective type of folding request of the plurality of types of folding requests; fetching data from the plurality of folding requests according to the plurality of credit values; and writing the fetched data from the plurality of the folding requests in parallel with writing the host data of the host write request.

### TECHNICAL FIELD

Embodiments of the disclosure relate generally to memory sub-systems, and more specifically, relate to multi-stream folding scheme in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates an example block diagram of a system that implements multi-stream folding scheme in a memory sub-system in accordance with some embodiments of the present disclosure.

FIG. 3 illustrates an example of the multiple folding streams in the multi-stream folding scheme in accordance with some embodiments of the present disclosure.

FIG. 4 illustrates an example data structure that stores the information of multi-stream folding scheme in a memory sub-system in accordance with some embodiments of the present disclosure.

FIG. 5 is a flow diagram of an example method for multi-stream folding scheme in a memory sub-system in accordance with some embodiments of the present disclosure.

FIG. 6 is a block diagram of an example computer system in which embodiments of the present disclosure may operate.

### DETAILED DESCRIPTION

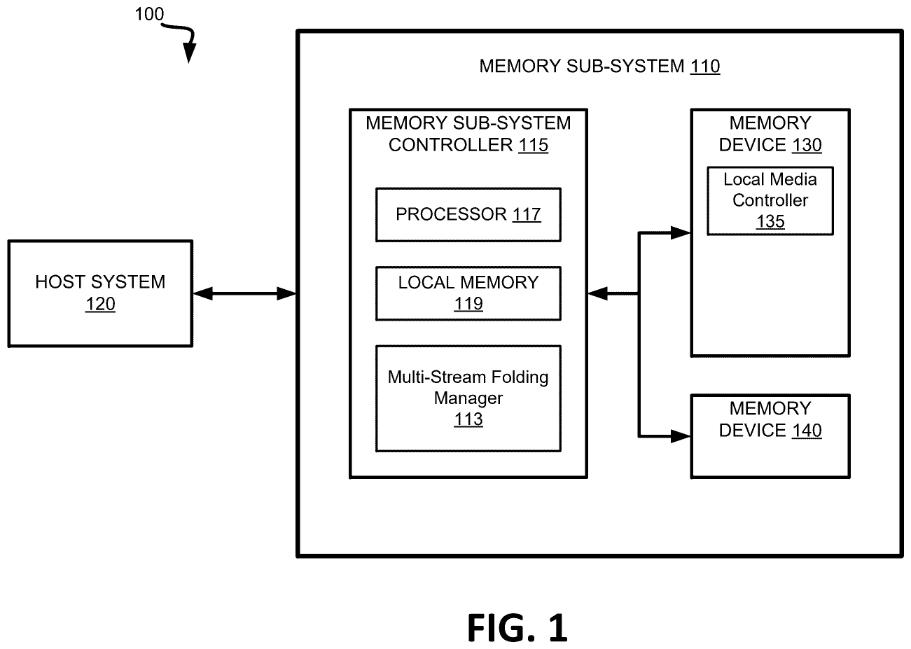

Aspects of the present disclosure are directed to multi-stream folding scheme in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can include one or more memory planes (“planes”). For some types of non-volatile memory devices (e.g., NAND devices), each plane includes a set of physical blocks (“blocks”). Each block includes a set of pages. Each page includes a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values. A block refers to a unit of the memory device used to store data and can include a group of memory cells, a word line group, a word line, or individual memory cells.

Memory access operations can be performed by the memory sub-system. The memory access operations can be host-initiated operations. For example, the host system can initiate a memory access operation (e.g., write, read, erase, etc.) on a memory sub-system. The host system can send access requests (e.g., write command, read command) to the memory sub-system, such as to store data in the memory device at the memory sub-system and to read data from the memory device of the memory sub-system. The data to be read or written, as specified by a host request, is referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), and the like. For simplicity, where “data” is referred to hereafter, such data can be understood to refer to at least host data, but can also refer to other data such as media management data and/or system data.

A memory device can include multiple memory cells arranged in a two-dimensional grid. The memory cells are formed onto a silicon wafer in an array of columns (also hereinafter referred to as bitlines) and rows (also hereinafter referred to as wordlines). A wordline can refer to memory cells in a row, and a bitline can refer to memory cells in a column. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

As described above, a die can contain one or more planes. A memory sub-system can use a striping scheme to treat various sets of data as units when performing data operations (e.g., write, read, erase, etc.). A die stripe refers to a collection of planes that are treated as one unit when writing, reading, or erasing data. A controller of a memory device (i.e., a memory sub-system controller, a memory device controller, etc.) can execute the same operation, in parallel, at each die. A block stripe is a collection of blocks, at least one from each plane of a die stripe, that are treated as a unit. The blocks in a block stripe can be associated with the same block identifier (e.g., block number) at each respective plane. A page stripe is a set of pages having the same page identifier (e.g., the same page number), across a block stripe, and treated as a unit.

One type of cell is a single level cell (SLC), which stores 1 bit per cell and defines 2 logical states (“states”) (“1” or “L0” and “0” or “L1”) each corresponding to a respective V_{T} level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2ⁿ levels of charge to store n bits. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

Some memory devices can perform a media management operation, such as a folding operation, across management units of a memory device. A management unit refers to a particular amount of memory, such as a page or a block, of a memory device. The folding operation involves copying data from a source management unit (e.g., a block, superblock, a page, etc.) to a destination management unit (e.g., a block, superblock, a page, etc.) available on the memory device. For example, the folding operation includes retrieving data from the source management units (e.g., as a cache) and programming the data on certain types of memory cells in the destination management units.

Some memory sub-systems, such as those including multiple memory devices (i.e., memory dies) can perform memory access operations to write host data to the memory devices concurrently with performing the folding operations in the memory devices. This allows host data to be written at the same time that a folding operation is occurring, thereby increasing the quality of service (QoS) and performance of the memory sub-system. To maintain a good overall QoS, the ratio of management units used for host write and management units used for folding operation needs to be controlled. For example, the number of the blocks that are freed by the folding operation may be made to be equal to the number of blocks that are written with the host data and the valid data in the folding operation, which can be referred to as steady state of the blocks. When such steady state is maintained, the ratio of amount of the valid data in the source block to amount of the host data needs to be controlled such that enough host data can be written to maintain the performance of the memory sub-system.

The folding operation may be performed for various purposes, including garbage collection, data reliability such as read disturb, data retention, wear leveling, or other purposes such as testing. Garbage collection is a process to recover free space by relocating pages with valid data to new blocks, and erasing old blocks. Specifically, a block can include valid data pages and data pages that are no longer needed (e.g., stale pages). Garbage collection generally involves copying only the valid data from a source block to a destination block and then erasing the source block to free the space. As a result, the number of blocks that have been erased can be increased such that more blocks are available to store subsequent data from a host system.

Read disturb is the result of continually reading from memory cells without intervening erase operations, causing other memory cells on other nearby wordlines to change over time. That is, when data is read from a memory cell on a given wordline of the memory device, the memory cells on all of the other wordlines on the memory device can experience read disturb. The memory cells of each wordline of the memory device can handle a certain number of consecutive read operations before the memory cells are no longer able to reliably retrieve the data, reaching a read disturb capability limit (e.g., a threshold number of read operation limit at which point retrieved data is no longer reliable). If too many read operations are performed on the memory cells of a given wordline, data stored at memory cells of nearby or adjacent wordlines of the memory device can become corrupted or incorrectly stored at the memory cell. As such, the folding operation is performed to reduce the effects of the read disturb.

Data retention capability refers to the ability of a memory device to retain stored data (i.e., retain a charge to remain at a particular programming level) for a specified period and can be reduced due to the electron escape. In some cases, an element of a memory device can be defined to have reached the extent of its data retention capability when its level of degradation causes a failure in memory device operation (e.g., when the memory device cannot reliably read data from the component). For example, a block of a memory device can be said to have reached the end of its data retention capability if its memory cells have degraded to such a point that the memory device cannot reliably read data from the memory cells on the block (i.e., when attempts to read data from the memory cells on the die result in a rate of errors that exceeds the ability of the device to correct them). As such, the folding operation is performed to improve the data retention capability.

To mitigate the effect of physical wear on the memory devices and lengthen the overall lifetime of the memory sub-system, the memory sub-system controller can perform a wear leveling operation to distribute the physical wear across management units of a memory device. To perform a wear leveling operation, the memory sub-system controller can identify a management unit at a memory device that is subject to a significant amount of physical wear and can move data stored at the management unit to another management unit subject to a smaller amount of physical wear. In some instances, a management unit can be subject to a significant amount of physical wear if a large number of memory access operations, such as write operations (i.e., program operations) or read operations, are performed at the management unit. As such, in some implementations, the memory sub-system controller can identify management units that are subject to large amounts of physical wear based, for example, on write counts for each management unit. A write count refers to a number of times that the memory sub-system controller performs a write operation at a particular management unit over the lifetime of the management unit. The data from a management unit having a high write count can be swapped with the data of a management unit having low write count in an attempt to evenly distribute the wear across the management units of the memory component.

As described above, the folding operations may be performed for various purposes. Each type of the folding operations can have different valid translate unit count (VTC) rates, where the VTC rate refers to a ratio of the number of translate units storing valid data to the total number of translate units used in the folding operation. The VTC rates in the folding operations may affect the ratio of the amount of the valid data to the amount of the host data, and thus, the performance of the host write. For example, the VTC rate in the garbage collection may be 2:3, and as such, the ratio of the number of dies used for host writes and the number of dies used for folding operations may be 1:2. While the VTC rate in the data retention may be 9:10, and as such, the ratio of the number of dies used for host writes and the number of dies used for folding operations may be 1:9. Therefore, the amount of host data that can be written during one programming cycle of the folding operation during the garbage collection is larger than that during the data retention. That is, the performance such as the host write speed will be reduced sharply (e.g., by around 10/3 times). This is especially the case in some systems that the folding operations are performed one by one in a single stream, such as a garbage collection followed by a read disturb, in parallel with the host write, which can cause the sharp drop in the performance, such as the host write speed.

Aspects of the present disclosure address the above and other deficiencies by implementing a memory sub-system that provides multi-stream folding scheme in parallel with the host write. In contrast to using single-stream folding scheme, which takes the requests of folding operation in a single stream in parallel with host write as described above, a memory sub-system controller can fetch the multiple requests of folding operations according to credit values that are assigned to each request, and write data of the fetched requests in parallel with host write, which can result in better performance, including the host write speed at a stable level.

Specifically, the memory sub-system controller may receive, from a host system, a request to write host data (“host write request”), and receive, from the host system or the memory sub-system, multiple requests of folding operations (“folding requests”). For each of the folding requests, the memory sub-system controller may identify the type of the folding request, where the type of the folding request may include a type for garbage collection, a type for read disturb, a type for data retention, a type for wear leveling, etc. The memory sub-system controller may assign a credit value to each folding request based on the type of the folding request. For example, the memory sub-system controller may access to a predetermined data structure that records a type of the folding request with a corresponding credit value. The credit value in the data structure may be predetermined according to the time duration of the folding operation in the specific type (e.g., garbage collection, read disturb, data retention, wear leveling, etc.). The credit value may reflect a ratio of the number of management units used for the folding operation in the specific type to the total number of management units used for the folding operation in all types.

The memory sub-system controller may fetch the folding requests according to the credit values. For example, the memory sub-system controller may fetch the number of folding requests in the first type according to the first credit value assigned to the folding requests in the first type, fetch the number of folding requests in the second type according to the second credit value assigned to the folding requests in the second type, etc. The memory sub-system controller may write the data of the fetched folding requests in parallel with writing the host data. As such, data from folding operation and host data are written in a relatively stable proportion, resulting in stable host write speed.

Advantages of the present disclosure include, but are not limited to achieving better parallelism across the dies of a memory device for host write and folding operation. The memory sub-system controller can avoid writing limited host data while performing the folding operation of some types in the memory device. Accordingly, the overall QoS and performance of the memory sub-system can be improved.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 includes local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes a multi-stream folding manager 113 that can implement multi-stream folding scheme while performing host writes in the memory device(s), such as memory device 130. In some embodiments, memory sub-system controller 115 includes at least a portion of multi-stream folding manager 113. In other embodiments, local media controller 135 includes at least a portion of multi-stream folding manager 113 and is configured to perform the functionality described herein. Further details with regards to the operations of multi-stream folding manager 113 are described below.

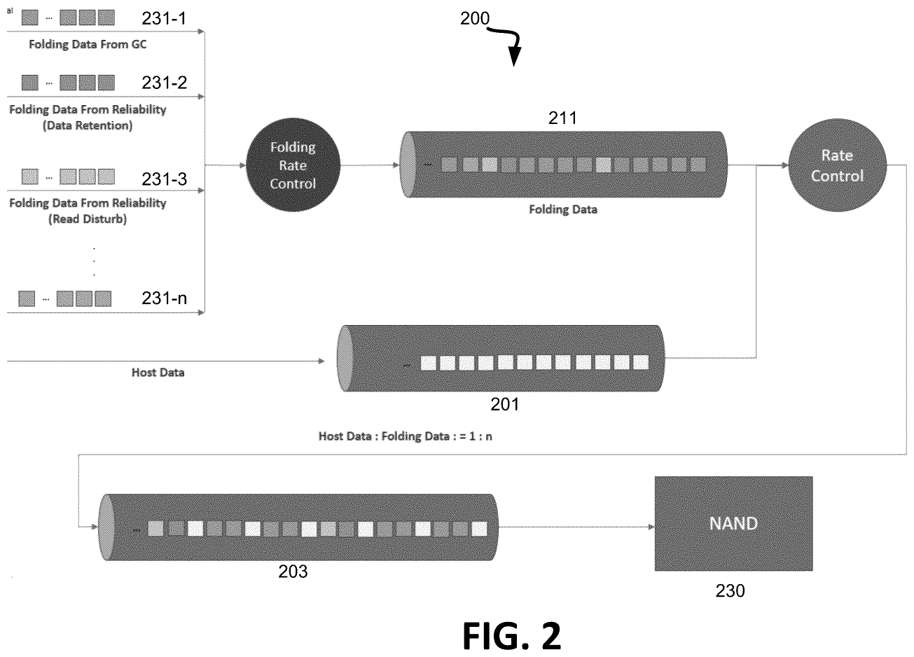

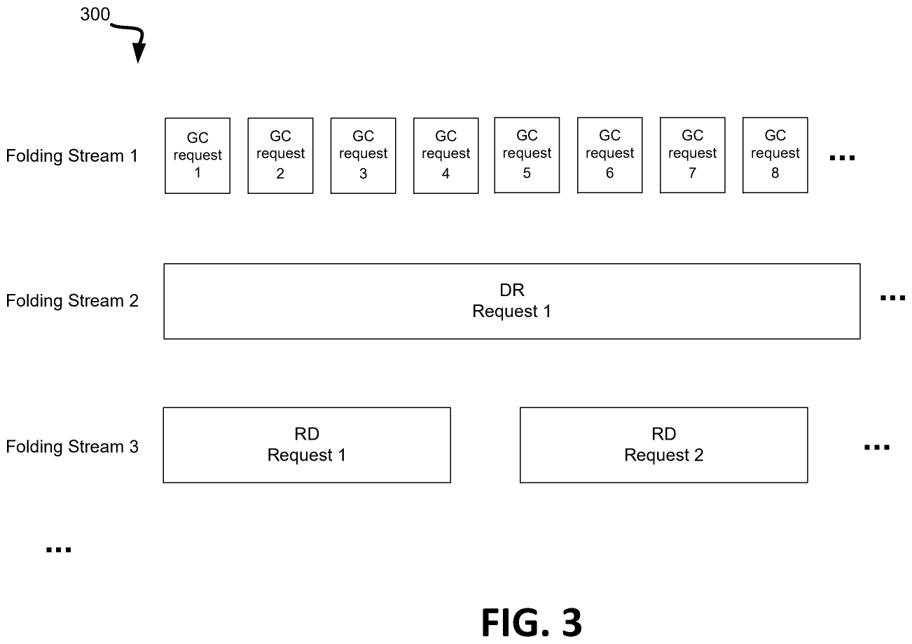

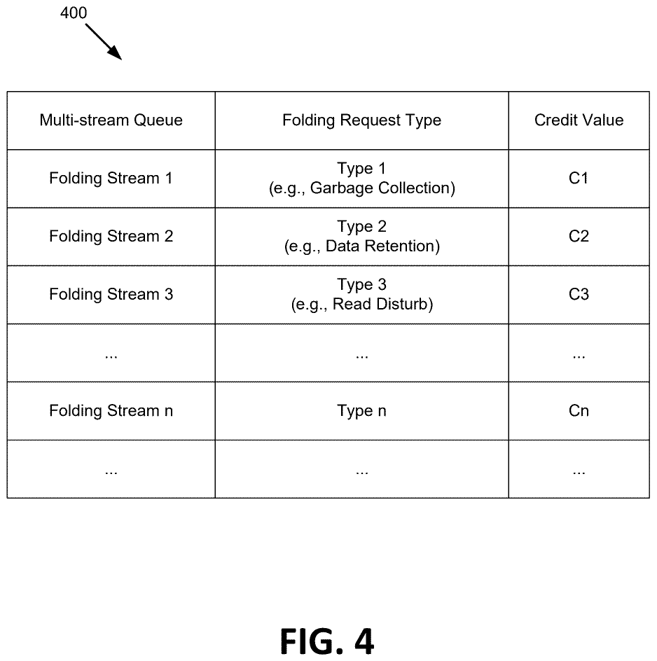

FIG. 2 illustrates an example of writing host data to a memory device and at the same time performing multi-stream folding operations, within the memory device, from source memory arrays (e.g., management units, such as block stripes) to destination memory arrays (e.g., management units, such as block stripes). The example 200 can be performed by the memory sub-system controller 115 or the multi-stream folding manager 113. FIG. 3 illustrates an example of the multiple folding streams in the multi-stream folding scheme. FIG. 4 illustrates a data structure that stores the information of multi-stream folding scheme.

Referring to FIG. 2, the multi-stream folding manager 113 may receive multiple requests from the host system 120 and/or requests generated locally in the memory sub-system 110. The requests include at least one host write request and multiple folding requests. The multi-stream folding manager 113 can manage the requests such that writing host data to a memory device and performing multi-stream folding operations are fulfilled at the same time. The multi-stream folding manager 113 may receive, from the host system 120, a request to write host data in the memory device 130. The multi-stream folding manager 113 may receive multiple requests to perform folding operations, where these requests may be generated by the host system 120 or generated locally in the memory sub-system 110. For example, the folding operation may be performed to copy data of a block stripe from a source block to a destination block of the memory device 130.

Upon receiving the host write request, the multi-stream folding manager 113 can fetch, from the host system 120, the data that is specified by the host write request to be written to the memory device 130. As illustrated in the example of FIG. 2, the multi-stream folding manager 113 may configure a queue (“host write queue”) 201 to store the host write request. The host write queue 201 can hold a specific number of host write requests of writing the host data.

The multi-stream folding manager 113 may configure multiple queues (“multi-stream queues”) 231-1, 231-2, . . . 231-n to store the folding requests. Each of the multi-stream queues 231-1, 231-2, . . . 231-n can hold a specific number of requests of folding operations in a specific type. The type of folding request may include a type for garbage collection, a type for read disturb, a type for data retention, a type for wear leveling, etc. For example, a first type of the folding request may be a folding request for garbage collection, a second type of the folding request may be a folding request for data retention, a third type of the folding request may be a folding request for read disturb, a fourth type of the folding request may be a folding request for wear leveling, etc. As illustrated in the example of FIG. 2, the multi-stream queue 231-1 may hold a number of folding requests of the type for garbage collection, the multi-stream queue 231-2 may hold a number of folding requests of the type for data retention, the multi-stream queue 231-3 may hold a number of folding requests of the type for read disturb, etc.

As each multi-stream queue is specific to a type of folding request described above, the multi-stream folding manager 113 may assign a specific credit value to each multi-stream queue. The credit value for a multi-stream queue may reflect a ratio of the number of management units of a memory device used for the multi-stream queue to the total number of management units of a memory device used for the multi-stream queues. In some cases, when the total credit value that is assigned to the total number of management units of a memory device used for the multi-stream queues is known, the credit value may be an absolute value.

In some implementations, the multi-stream folding manager 113 may access to a predetermined data structure (e.g., stored in the memory sub-system controller 115) that records a type of the folding request with a corresponding credit value. FIG. 4 illustrates an example data structure that stores the information of multi-stream folding scheme in a memory sub-system. Referring to FIG. 4, the data structure 400 may include a set of records, and each record may specify a type of folding request and its corresponding credit value. In some cases, each record may further specify a multi-stream queue (e.g., queue ID such as folding stream 1, folding stream 2, etc.) that can be used to store the folding request in the specific type.

The credit value in the data structure may be predetermined according to the time duration of the folding operation in the specific type (e.g., garbage collection, read disturb, data retention, wear leveling, etc.). Specifically, the credit value may be determined based on the time duration that is supposed to be used for completing the requested folding operation. In some implementations, the credit value may be inversely proportional to the time duration that is supposed to be used for completing the requested folding operation. In one example, the folding request is in a garbage collection type, the folding operation of the garbage collection may need to be completed in the time duration P1 (e.g., 5s), and the credit value may be determined as C1 (e.g., 1000). In another example, the folding request is in a data retention type, the folding operation of the data retention may need to be completed in the time duration P2 (e.g., 500s), and the credit value may be determined as C2 (e.g., 10). In yet another example, the folding request is in a read disturb type, the folding operation of the read disturb may need to be completed in the time duration P3 (e.g., 250s), and the credit value may be determined as C3 (e.g., 20).

While receiving the multiple folding requests, the multi-stream folding manager 113 may identify each request as a request of folding operation in a specific type. For example, the multi-stream folding manager 113 may identify the first request as a request of folding operation in a first type (e.g., garbage collection), the second request as a request of folding operation in a second type (e.g., data retention), the third request as a request of folding operation in the first type (e.g., garbage collection), etc.

The multi-stream folding manager 113 may place the request in a multi-stream queue according to the specific type in which the request of folding operation is identified as. For example, the multi-stream folding manager 113 may place the first request (in a first type (e.g., garbage collection)) in multi-stream queue 231-1, the second request (in a second type (e.g., data retention)) in multi-stream queue 231-2, and the third request (in a first type (e.g., garbage collection)) in multi-stream queue 231-1. FIG. 3 illustrates multiple folding streams in the multi-stream folding scheme. Folding stream 1 may represent a multi-stream queue that can be used to store the folding request in the garbage collection type (GC request); folding stream 2 may represent a multi-stream queue that can be used to store the folding request in the data retention type (DR request); folding stream 3 may represent a multi-stream queue that can be used to store the folding request in the read disturb type (RD request), etc.

The multi-stream folding manager 113 may perform a control on multi-stream folding operations by fetching the requests from each of the multi-stream queues according to the credit values. For example, the multi-stream folding manager 113 may fetch the number C1 of the requests (e.g., 1000 requests) from multi-stream queue 231-1, the number C2 of the requests (e.g., 10 requests) from multi-stream queue 231-2, the number C3 of the requests (e.g., 20 requests) from multi-stream queue 231-3. The multi-stream folding manager 113 may place the fetched requests in the folding data queue 211. The folding data queue 211 holds a specific number of requests of folding operations. The number of requests (that are fetched) in a specific type corresponds to the respective credit value (determined as described above). For example, the number of requests (that are fetched) in a specific type may be the same as the respective credit value. In another example, the number of requests (that are fetched) in a specific type may be proportional to the respective credit value.

The multi-stream folding manager 113 may perform a control on paralleling the host write operation of host data in the host write queue 201 with the folding operation of folding data in the folding data queue 211. The multi-stream folding manager 113 may fetch the requests from each of the queues 201, 211 according to a predetermined value (e.g., VTC rate) to a parallel queue 203. The multi-stream folding manager 113 may then write the data of the parallel queue 203 in the memory device 230 (e.g., NAND).

In some implementations, the multi-stream folding manager 113 can send a notification that the write operation of the host data has been completed and the folding operation of the valid data has been completed. When the write operation and folding operation are completed, a completion notification is sent back to the process that initiated the write operations. In some implementations, the multi-stream folding manager 113 can communicate to a host system 120 upon completing each programming cycle or multiple programming cycles.

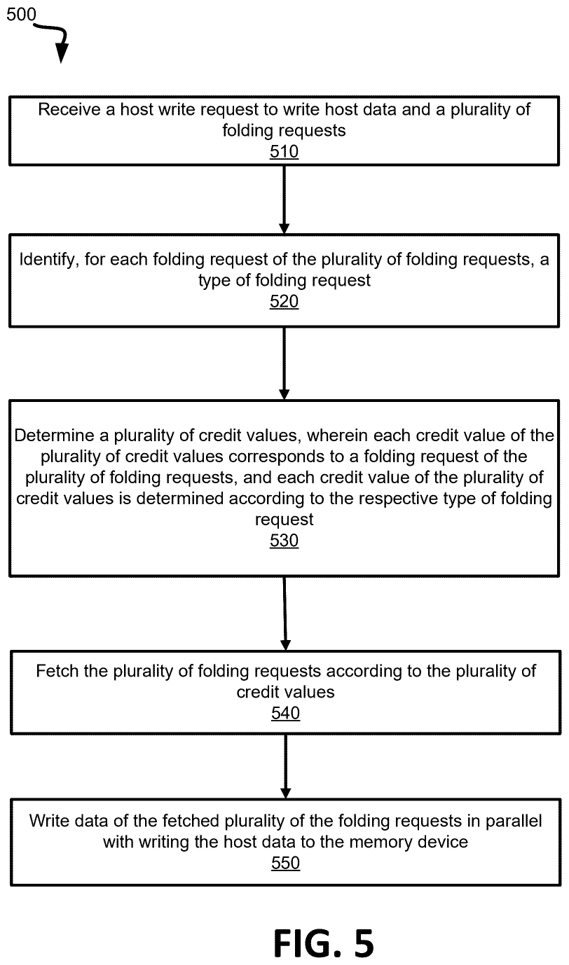

FIG. 5 is a flow diagram of an example method 500 for multi-stream folding scheme in a memory sub-system, in accordance with some embodiments of the present disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the multi-stream folding manager 113 of FIGS. 1 and 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Referring to FIG. 5, at operation 510, the processing logic may receive a write request of host data and a plurality of folding requests. In some implementations, the processing logic may receive, from a host system (e.g., the host system 120), a host write request to write host data to a memory device (e.g., memory device 130), and at the same time, receive, from the host system (e.g., the host system 120) or the memory sub-system (e.g., the memory sub-system 110), a plurality of folding requests to perform a plurality of folding operations in the memory device (e.g., memory device 130), wherein each folding request of the plurality of folding requests corresponds to a respective folding operation of the plurality of folding operations. For example, the processing logic may receive a request to perform a write request from a host system (e.g., the host system 120), and the write request may include a logical address of the data (e.g., the LBA associated with the write operation). The LBA can reference pages on which the write operation is to be performed. The processing logic may receive one or more folding requests to perform a folding operation of the garbage collection, and one or more folding requests to perform a folding operation of the data retention or the read disturb.

At operation 520, the processing logic may identify, for each folding request of the plurality of folding requests, a type of folding request of a plurality of types of folding requests. In some implementations, each folding request may include information specifying the type of the folding request. In some implementations, the processing logic may configure a plurality of multi-stream queues (e.g., multi-stream queues 231-1, 231-2, etc.), and place each folding request of the plurality of folding requests in one or more multi-stream queues of the plurality of multi-stream queues according to the type of folding request. In some implementations, the plurality of types of folding requests comprise at least two of: a request type of garbage collection, a request type of data reliability, or a request type of testing. In some implementations, the plurality of types of folding requests comprise at least two of: a request type of garbage collection, a request type of data retention, a request type of read disturb, or a request type of wear leveling.

At operation 530, the processing logic may determine a plurality of credit values, wherein each credit value of the plurality of credit values corresponds to a folding request of the plurality of folding requests and reflects a relative number of management units used to fulfill a corresponding folding request, and each credit value of the plurality of credit values is determined according to the respective type of folding request of the plurality of types of folding requests. In some implementations, each credit value of the plurality of credit values is determined according to a data structure, wherein the data structure include a set of records, each record specifies a type of folding request and a corresponding credit value. In some implementations, each credit value of the plurality of credit values is determined according to a time duration used for the respective type of folding request.

At operation 540, the processing logic may fetch data from the plurality of folding requests according to the plurality of credit values. In some implementations, the processing logic may place the plurality of folding requests in a folding data queue (e.g., folding data queue 211) according to the plurality of credit values. In some implementations, the first credit value is determined according to a first type of the folding request, the second credit value is determined according to a second type of the folding request, to fetch data from the plurality of folding requests according to the plurality of credit values, the processing logic may fetch a first number of the folding requests that are in the first type of the folding request and fetch a second number of the folding requests that are in the second type of the folding request, where the first number corresponds to (e.g., being the same as, or being proportional to) the first credit value, and the second number corresponds to (e.g., being the same as, or being proportional to) the second credit value. In some implementations, to fetch data from the plurality of folding requests according to the plurality of credit values, the processing logic may fetch a respective number of the folding requests that are in a corresponding type of the folding request, where the respective number corresponds to (e.g., being the same as, or being proportional to) a respective credit value, and the respective credit value is determined according to the respective type of folding request.

At operation 550, the processing logic may write the fetched data from the plurality of the folding requests in parallel with writing data of the write request to the memory device (e.g., memory device 130). In some implementations, the processing logic may fetch data in the folding data queue and the host data according to a predetermined value (e.g., VTC rate). In some implementations, the processing logic may place the data in the folding data queue and the host data in a parallel queue (e.g., parallel queue 203) according to the predetermined value (e.g., VTC rate). In some implementations, the processing logic may write the fetched data from the plurality of the folding requests in parallel with writing data of the write request by writing the data in the parallel queue (e.g., parallel queue 203) to the memory device (e.g., memory device 130).

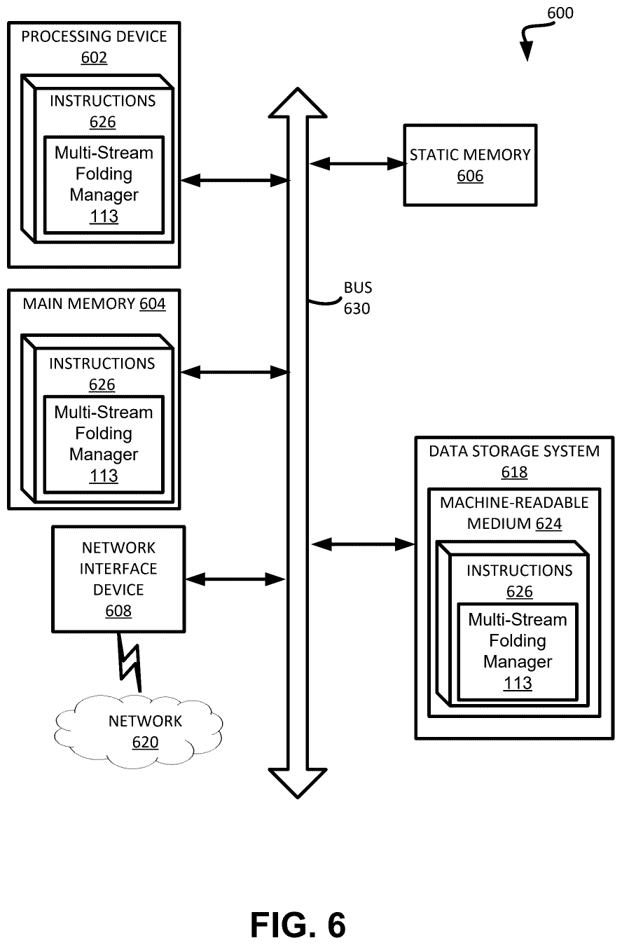

FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the multi-stream folding manager 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a command fetching logic management component (e.g., the multi-stream folding manager 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a host write request to write host data to the memory device;
receiving a plurality of folding requests to perform a plurality of folding operations in the memory device, wherein each folding request of the plurality of folding requests corresponds to a respective folding operation of the plurality of folding operations;
identifying, for each folding request of the plurality of folding requests, a type of folding request of a plurality of types of folding requests;
determining a plurality of credit values, wherein each credit value of the plurality of credit values corresponds to a respective folding request of the plurality of folding requests, and wherein each credit value of the plurality of credit values is determined according to a respective type of folding request of the plurality of types of folding requests;
fetching data from the plurality of folding requests according to the plurality of credit values; and
writing the fetched data from the plurality of the folding requests in parallel with writing the host data of the host write request.

2. The system of claim 1, wherein fetching data from the plurality of folding requests according to the plurality of credit values further comprises:
placing the data from the plurality of folding requests in a folding data queue according to the plurality of credit values.

3. The system of claim 2, wherein the operations further comprise:
fetching data in the folding data queue and the host data according to a predetermined value.

4. The system of claim 1, wherein the operations further comprise:
configuring a plurality of multi-stream queues; and
placing each folding request of the plurality of folding requests in one or more multi-stream queues of the plurality of multi-stream queues according to the type of folding request.

5. The system of claim 1, wherein the plurality of types of folding requests comprise at least two of: a request type of garbage collection, a request type of data reliability, or a request type of testing.

6. The system of claim 1, wherein the plurality of types of folding requests comprise at least two of: a request type of garbage collection, a request type of data retention, a request type of read disturb, or a request type of wear leveling.

7. The system of claim 1, wherein each credit value of the plurality of credit values is determined according to a time duration used for the respective type of folding request.

8. A method comprising:
receiving, by a processing device, a host write request to write host data to a memory device;
receiving a plurality of folding requests to perform a plurality of folding operations in the memory device, wherein each folding request of the plurality of folding requests corresponds to a respective folding operation of the plurality of folding operations;
identifying, for each folding request of the plurality of folding requests, a type of folding request of a plurality of types of folding requests;
determining a plurality of credit values, wherein each credit value of the plurality of credit values corresponds to a respective folding request of the plurality of folding requests, and wherein each credit value of the plurality of credit values is determined according to a respective type of folding request of the plurality of types of folding requests;
fetching data from the plurality of folding requests according to the plurality of credit values; and
writing the fetched data from the plurality of the folding requests in parallel with writing the host data of the host write request.

9. The method of claim 8, wherein fetching data from the plurality of folding requests according to the plurality of credit values further comprises:
placing the data from the plurality of folding requests in a folding data queue according to the plurality of credit values.

10. The method of claim 9, further comprising:
fetching data in the folding data queue and the host data according to a predetermined value.

11. The method of claim 8, further comprising:
configuring a plurality of multi-stream queues; and
placing each folding request of the plurality of folding requests in one or more multi-stream queues of the plurality of multi-stream queues according to the type of folding request.

12. The method of claim 8, wherein the plurality of types of folding requests comprise at least two of: a request type of garbage collection, a request type of data reliability, or a request type of testing.

13. The method of claim 8, wherein the plurality of types of folding requests comprise at least two of: a request type of garbage collection, a request type of data retention, a request type of read disturb, or a request type of wear leveling.

14. The method of claim 8, wherein each credit value of the plurality of credit values is determined according to a time duration used for the respective type of folding request.

15. A non-transitory computer-readable storage medium comprising instructions that, when executed by a processing device, cause the processing device to perform operations comprising:
receiving a host write request to write host data to a memory device;
receiving a plurality of folding requests to perform a plurality of folding operations in the memory device, wherein each folding request of the plurality of folding requests corresponds to a respective folding operation of the plurality of folding operations;
identifying, for each folding request of the plurality of folding requests, a type of folding request of a plurality of types of folding requests;
determining a plurality of credit values, wherein each credit value of the plurality of credit values corresponds to a respective folding request of the plurality of folding requests, and wherein each credit value of the plurality of credit values is determined according to a respective type of folding request of the plurality of types of folding requests;
fetching data from the plurality of folding requests according to the plurality of credit values; and
writing the fetched data from the plurality of the folding requests in parallel with writing the host data of the host write request.

16. The non-transitory computer-readable storage medium of claim 15, wherein fetching data from the plurality of folding requests according to the plurality of credit values further comprises:
placing the data from the plurality of folding requests in a folding data queue according to the plurality of credit values.

17. The non-transitory computer-readable storage medium of claim 15, wherein the operations further comprise:
configuring a plurality of multi-stream queues; and
placing each folding request of the plurality of folding requests in one or more multi-stream queues of the plurality of multi-stream queues according to the type of folding request.

18. The non-transitory computer-readable storage medium of claim 15, wherein the plurality of types of folding requests comprise at least two of: a request type of garbage collection, a request type of data reliability, or a request type of testing.

19. The non-transitory computer-readable storage medium of claim 15, wherein the plurality of types of folding requests comprise at least two of: a request type of garbage collection, a request type of data retention, a request type of read disturb, or a request type of wear leveling.

20. The non-transitory computer-readable storage medium of claim 15, wherein each credit value of the plurality of credit values is determined according to a time duration used for the respective type of folding request.
